(19) United States
(12) Patent Application Publication
(10) Pub. No.: US 2024/0233430 A9
(43) Pub. Date: Jul. 11, 2024

(54) SYSTEM TO EXTRACT CHECKBOX SYMBOL AND CHECKBOX OPTION PERTAINING TO CHECKBOX QUESTION FROM A DOCUMENT

(71) Applicant: Infrrd Inc, San Jose, CA (US)

(72) Inventor: Srirama R Nakshathri, Bengaluru (IN)

(73) Assignee: Infrrd Inc, San Jose, CA (US)

(21) Appl. No.: 18/048,030

(22) Filed: Oct. 20, 2022

(51) Int. Cl. G06V 30/412; G06F 40/284; G06F 40/30

(52) U.S. Cl. CPC G06V 30/412; G06F 40/284; G06F 40/30

(57) ABSTRACT

A system to extract checkbox symbol and checkbox option pertaining to checkbox question from a document is provided. The system comprises of processors configured to identify location of checkbox symbols and their relative location with respect to checkbox options. The processor is configured to determine context of textual information corresponding to checkbox options using textual processing and a pictorial representation of non-textual information corresponding to checkbox symbols using visual processing is detected. The processor is configured to group the textual information corresponding to the checkbox options with the corresponding checkbox symbols by unique visual token using the textual processing and the visual processing on the document. The unique visual token is utilized as an anchor to group the textual information with the non-textual information in the digital document. The processor is configured to identify at least a link between the checkbox options with corresponding checkbox questions.

### BACKGROUND

Unless otherwise indicated herein, the materials described in this section are not prior art to the claims in this application and are not admitted to being prior art by inclusion in this section.

### FIELD OF THE INVENTION

The subject matter in general relates to the field of document management and processing. More particularly, but not exclusively, the subject matter relates to a system for detecting and extracting checkbox and checkbox options pertaining to checkbox questions from a digital document.

### DISCUSSION OF THE RELATED ART

In this generation of digital transformation, extraction of information is one of the key areas in almost every business enterprise. The extraction of information involves transforming unstructured data from various sources into structured data using various conventional natural language processing (NLP) and computer vision techniques. As easy it sounds, the implementation is quite tedious and most of the times generates false positives and false negatives for various fields in the data source. For instance, imagine the most common scenario of initial screening test in competitive examinations where an application has multiple choice questions where a given question has four options. The applicant is required to select a correct option from the list of options. The selected option by the applicant needs to be recorded. In this scenario, as easy it sounds, the extraction of such information (both textual and non-textual information) from such documents comprising various multi-choice question(s), option(s) and checkboxes(s) is cumbersome. Manual recordal of results of multiple questions is nearly impossible, whereas digitization of such documents has another bunch of issues.

In conventional document processing systems, there are a lot of processes that are utilized for analysing various fields in the documents. However, checkboxes are often overlooked due to being difficult entities for detection. Locating and determining status of checkboxes, whether selected or un-selected could be utilized as a useful tool in document processing. However, it is quite a tedious task to detect checkboxes since there could be multiple ways a person could mark a checkbox. Even though there are various conventional technologies which have succeeded in detection of checkboxes to some extent, they are specific to certain type of document. As a matter of fact, conventional technologies have failed to propose checkbox detection and extraction irrespective of the type of document being utilized.

In yet another approach towards information extraction, various templates are designed in order to capture the selected option(s) from a template-based document. Such a template-based solutions are specific to type and format of the document and requires standardization with respect to the format of the document. For instance, optical mark recognition (OMR) application is standardized technology which requires specially designed forms, that is OMR specified forms. Such a technology often fails to work since the location of user selected option(s) could vary from one template to another template. When there is huge amount of data set including unstructured data and without any standardized template, OMR often fails to provide the required output.

In view of the forgoing discussion and issues with the existing conventional document processing systems, there is a need for a technical solution for improving information extraction from the documents of any type, irrespective of any standardized template with the detection of checkbox(s), related option(s), and related question(s) with respect to the checkboxes, from the documents.

### SUMMARY

In an embodiment, a system for detecting and extracting at least one checkbox symbol and a checkbox option pertaining to a checkbox question from a digital document is disclosed. The system comprises one or more processors configured to identify location of at least one checkbox symbol and its relative location with respect to the at least one checkbox option. The processor is configured to determine context of textual information corresponding to the at least one checkbox option using textual processing. A pictorial representation of non-textual information corresponding to the at least one checkbox symbol using visual processing is detected. The processor is configured to group the textual information corresponding to the at least one checkbox option with the corresponding at least one checkbox symbol by a unique visual token using the textual processing and the visual processing on the document. The unique visual token is utilized as an anchor to group the textual information with the non-textual information in the digital document. The processor may be configured to identify at least a link between the at least one checkbox option with its corresponding at least one checkbox question.

### BRIEF DESCRIPTION OF DRAWINGS

This disclosure is illustrated by way of example and not limitation in the accompanying figures. Elements illustrated in the figures are not necessarily drawn to scale, in which like references indicate similar elements and in which:

FIG. 1 illustrates a system 100 for checkbox symbol detection and extraction, in accordance with an embodiment;

FIG. 2 illustrates an excerpt from a sample document 200 comprising checkbox symbols, in accordance with an embodiment;

FIG. 3 illustrates an excerpt from a sample document 300 comprising checkbox symbols of a different symbolic representation, in accordance with an embodiment;

FIG. 4 illustrates a block diagram 400 of the system 100 comprising various models and modules, in accordance with an embodiment;

FIG. 5 depicts a flowchart 500 illustrating checkbox detection process, in accordance with an embodiment;

FIG. 6 illustrates a sample document 600 comprising a plurality of checkbox options 602, 604, 606, 608, in accordance with an embodiment;

FIG. 7A is a flowchart 700 illustrating pre-processing of the textual information using an OCR module 404, in accordance with an embodiment;

FIG. 7B is a flowchart 750 illustrating training and working of a second machine learning model 410, in accordance with an embodiment;

FIGS. 8A-8B illustrate manual tagging of checkbox symbols 802, 808 checkbox options 804, 810 and checkbox questions 806, 812, in accordance with an embodiment;

FIG. 9 illustrates introduction of a unique visual token 902 in the sequence of text comprising checkbox options 804, 810 and checkbox questions 806, 812, in accordance with an embodiment;

FIG. 10 is a flowchart 1000 illustrating extraction of checkbox questions with corresponding selected options, in accordance with an embodiment;

FIG. 11 illustrates information pertaining to the checkbox options 1102 and the checkbox question 1104 fed to train a third machine learning model 412, in accordance with an embodiment;

FIGS. 12A-12B illustrate generation of a plurality of links 1200, 1202 between the checkbox options 1204, 1206 and the checkbox questions 1208, 1210 to train the third machine learning model 412, in accordance with an embodiment; and

FIG. 13 illustrates a hardware configuration of the system 100, in accordance with an embodiment.

### DETAILED DESCRIPTION OF THE INVENTION

The following detailed description includes references to the accompanying drawings, which form part of the detailed description. The drawings show illustrations in accordance with example embodiments. These example embodiments are described in enough detail to enable those skilled in the art to practice the present subject matter. However, it may be apparent to one with ordinary skill in the art that the present invention may be practised without these specific details. In other instances, well-known methods, procedures and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken in a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

It should be understood that the capabilities of the invention described in the present disclosure and elements shown in the figures may be implemented in various forms of hardware, firmware, software, recordable medium or combinations thereof.

The current disclosure provides a technical solution for extracting information from documents using supervised machine learning models. More particularly, the disclosure deals with training of the machine learning models to detect and extract checkbox symbols and by utilizing the extracted checkbox symbols, machine learning models are trained to extract corresponding checkbox options belonging to a checkbox question. As a matter of fact, it is required to identify the selected options from a list of options. Since the options may be placed in any order or format, the locations of the options may have to be located beforehand. A checkbox with a rectangular or circular shape may be provided near the vicinity of the options. The current invention makes use of the checkboxes to detect the location of the options, then use the detected checkbox locations to locate the options and extract the selected options from the list of options provided in the document.

### System 100

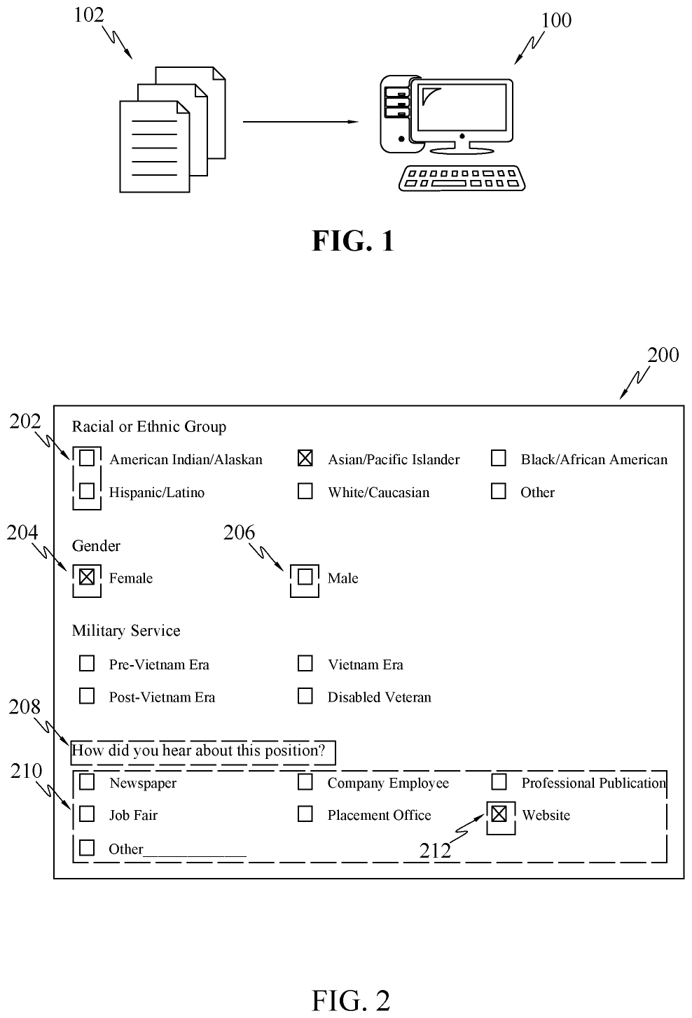

Referring to the figures, and more particularly to FIG. 1, a system 100 for checkbox symbol detection and extraction is disclosed, in accordance with an embodiment. The extracted checkbox symbol may be further utilized to extract corresponding checkbox option(s) pertaining to a checkbox question(s). A detailed explanation is provided later.

In an embodiment, the system 100 may be configured to receive one or more documents 102 as an input. The documents 102 may be of any type. The documents may not necessarily have any standardized format. For instance, the documents 102 may include invoices, receipts, records, payroll receipts, paid bills, bank statements, passports, income statements, medical appointment forms and college application forms, among others comprising checkbox symbols, checkbox options and checkbox questions. These documents 102 may not require to be of certain format and these documents 102 may directly be fed to the system 100 without any derivation of templates out of these documents 102.

In an embodiment, the documents 102 may be scanned documents, camera-captured documents, or digitally born documents so on and so forth.

In an embodiment, the system 100 may include smart phone, PDA, tablet PC, notebook PC, desktop, kiosk, or laptop, among like computing devices.

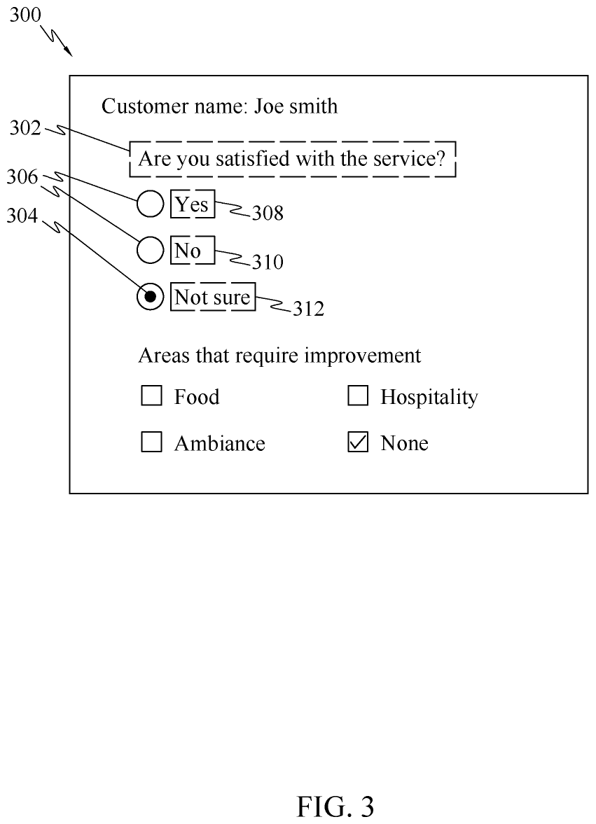

Referring to FIG. 2, an excerpt from a sample document 200 comprising checkbox symbols is illustrated, in accordance with an embodiment. The sample document 200 may be used just for the illustration and explanation purpose. For instance, in the sample document 200, checkbox symbols 202, 204 and 206 may be present. A plurality of checkbox options 210 belonging to a checkbox question 208 may be present in the sample document 200.

In an embodiment, the checkbox symbols 202 may be available in two statuses, that is selected 204 and unselected checkbox symbols 202, 206. For instance, the checkbox symbols 202, 206 may be considered unselected, since these are not selected by user and spaces within the checkbox symbols are empty.

In an embodiment, the selected checkbox symbols 204 may be considered as selected, when the spaces within the checkbox symbols are filled by the user.

In an embodiment, different shapes and varieties of checkboxes may be observed in documents. For instance, in the sample document 200, square shaped checkbox symbols 202, 204, 206 may be present. In cases of any conventional OMR sheet, the checkboxes may be circular in shape.

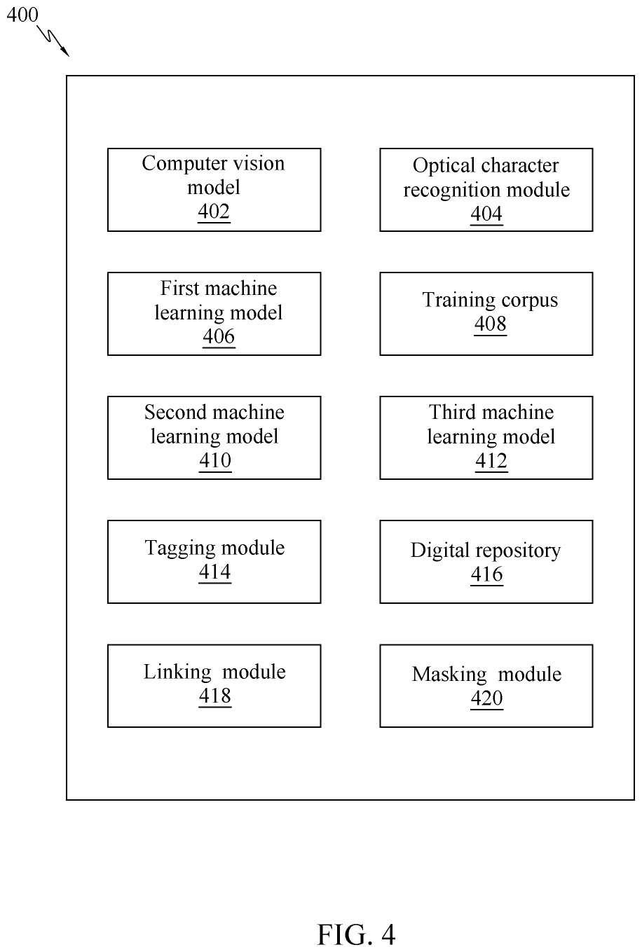

Referring to FIG. 3, an excerpt from a sample document 300 comprising checkbox symbols is illustrated, in accordance with an embodiment. For instance, in the sample document 300, checkbox symbols 304, 306 may be present wherein the checkbox symbols may have a circular shape. A plurality of checkbox options 308, 310 and 312 belonging to a checkbox question 302 may be present in the sample document 300.

In an embodiment, the checkbox symbols 304, 306 may be available in two statuses, that is selected 304 and unselected checkbox symbols 306. For instance, the checkbox symbols 306 may be considered unselected, since these are not selected by user. The checkbox symbols 304 may be considered selected, since these are selected by user.

### Block Diagram 400

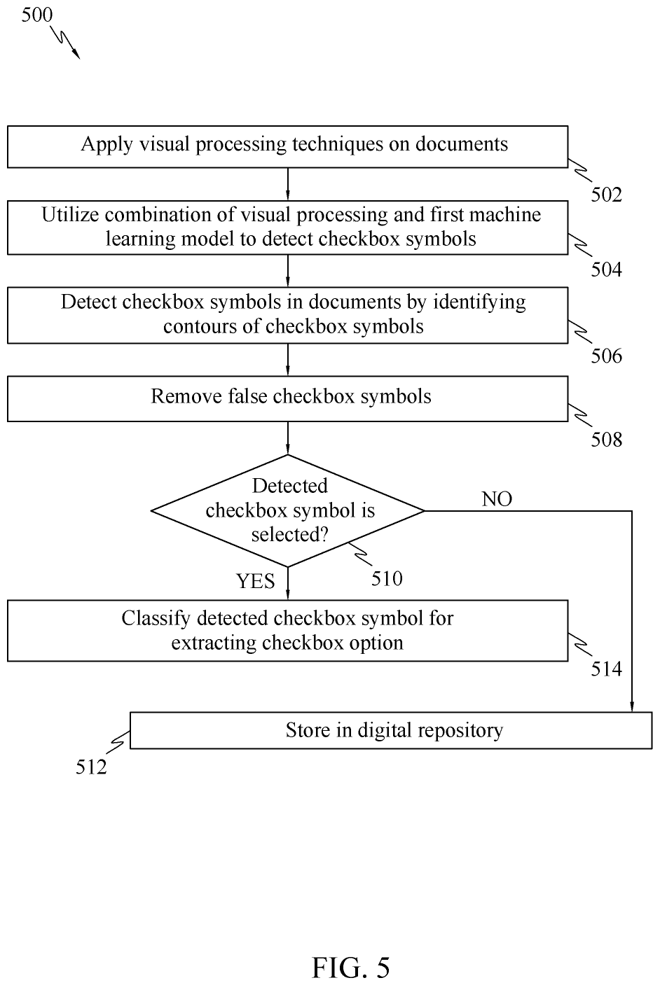

Referring to FIG. 4, a block diagram 400 of the system 100 is illustrated, in accordance with an embodiment.

In an embodiment, the system 100 may comprise a computer vision model 402 (CV model), an Optical character recognition (OCR) module 404, a first machine learning model 406, a training corpus 408, a second machine learning model 410, a third machine learning model 412, a tagging module 414, a digital repository 416, a linking module 418 and a masking module 420.

In an embodiment, the visual processing on digital image may be implemented by the computer vision model 402. The computer vision model 402 may be, but not limited to, a client-side machine learning model configured in the system 100. The CV model 402 may train the system 100 to capture and interpret information from digital image, specifically documents in present scenario. The CV model 402 may correspond to a processing block that may be trained to receive input information like digital images or videos and predict pre-learned concepts or labels. For instance, the CV model 402 may be pre-trained with image recognition, visual recognition and facial recognition technologies. As a matter of fact, the CV model 402 may be trained to visualize almost anything that humans can visualize. The CV model 402 may be a conventional computerized technique that may be trained to extract visual information from the documents. The visual information may aid users to analyse document, since interpretation becomes easy for humans when it comes to visual information.

In an embodiment, the CV model 402 may be customized by training with objective specific data that is unique to a person, business or project. The CV model 402 may predict required visual information based on scenarios-based training.

In an embodiment, the CV model 402 may be utilized to extract visual information and non-textual information from the digital document 200.

In an embodiment, referring to the sample document 200 of FIG. 2, the CV model 402 may be configured to detect checkbox symbols 202, 204, 206 in the documents 200. As discussed earlier, the checkbox symbols 202, 204, 206 may be present in a variety of shapes like square, rectangle, circular, oval, elliptical, square brackets or an underline, so on and so forth.

In an embodiment, the checkbox symbols 202, 204, 206 may be required to be detected to locate the checkbox options 210. For instance, referring to the sample document 200 in FIG. 2, a selected checkbox symbol may be related to a checkbox option 212 having word as “website”. The corresponding checkbox option 212 may be related to the checkbox question 208.

In an embodiment, the CV model 402 may be configured to utilize visual processing to detect the checkbox symbols 202, 204, 206. The document 200 may be converted into an image. The CV model 402 may utilize visual processing to detect checkbox symbols 202, 204, 206 in the digital image of the document 200.

In an embodiment, for instance, the OCR module 404 may be configured to extract textual information from the document 200 or digital image of the document 200. The OCR module 404 may recognize characters or words present in the digital image. In certain documents, context relating to the checkbox option 210 may be required. The checkbox options 210 may comprise multiple words to cover the context related to the checkbox option 210. For instance, referring to FIG. 2, in the sample document 200, words present in checkbox options may be “Newspaper”, “Company Employee”, “Professional Publication”, “Job Fair”, “Placement Office”, “Website” and “Other”.

In an embodiment, the OCR module 404 may be configured to process the textual information in the digital image of the document 200. The OCR module 404 may be configured to arrange words in a two-dimensional sequence based on the appearance of the words in the document. Each word in the document 200 may be recognized by utilizing the OCR module 404.

In an embodiment, the first machine learning model 406 may be trained to detect checkbox symbols 202, 204, 206 in the document 200. The first machine learning model 406 may be, but not limited to, a deep learning system or a neural network.

In an embodiment, the training corpus 408 of documents of various types, categories may be utilized as data set to train the first machine learning model 406. It may be understood that all the documents may comprise checkbox symbols, checkbox options belonging to a checkbox question.

In an embodiment, the OCR module 404 singlehandedly may not be effective in grouping the words present in the checkbox options 210. In order to improve context recognition and proper checkbox options extraction and grouping, the second machine learning model 410 may be trained to receive pre-processed textual information present in the digital image of the document 200 as input to further process textual information and to group words in checkbox options 210 with non-textual information comprising checkbox symbols 202, 204, 206. The second machine learning model 410 may be, but not limited to, a deep learning system or a neural network.

In an embodiment, referring to FIG. 2, once the words present in checkbox options 210 (textual information) are grouped with the checkbox symbols 202, 204, 206 (non-textual information) as discussed in foregoing, the selected checkbox symbol 204 with corresponding checkbox option (“Female”) may require to be extracted. The third machine learning model 412 may be trained to extract the checkbox option 210 corresponding to the selected checkbox symbol 212 pertaining to the corresponding checkbox question 208. The third machine learning model 412 may be, but not limited to, a deep learning system or a neural network.

In an embodiment, a combination of the first machine learning model 406, the second machine learning model 410 and the third machine learning model 412 may be utilized to extract the checkbox symbols, checkbox options and the checkbox question.

In an embodiment, the tagging module 414 may be configured to enable humans or users to tag information present in the digital document. The tagged data may later be evaluated by field practitioners for verification.

In an embodiment, for instance, the users may annotate or tag checkbox symbols 202, 204, 206, checkbox options 210 and checkbox question 208 present in the training corpus 408. The annotated data may be stored in the digital repository 416. The digital repository 416 may be a database that may be populated by receiving information from one or more information sources. The digital repository 416 may store, but not limited to, at least an information corresponding to the data extracted from the CV model 402, the OCR module 404 and the tagging module 414.

In an embodiment, the linking module 418 may be configured to enable humans or users to identify a link between the checkbox options 210 and corresponding checkbox question 208.

In an embodiment, the masking module 420 may be configured to mask the links that may be generated by the linking module 418 between the checkbox options 210 and corresponding checkbox question 208. It may be noted that, the linking module 418 and the masking module 420 may be explained later in detail.

### Detection of Checkbox Symbols

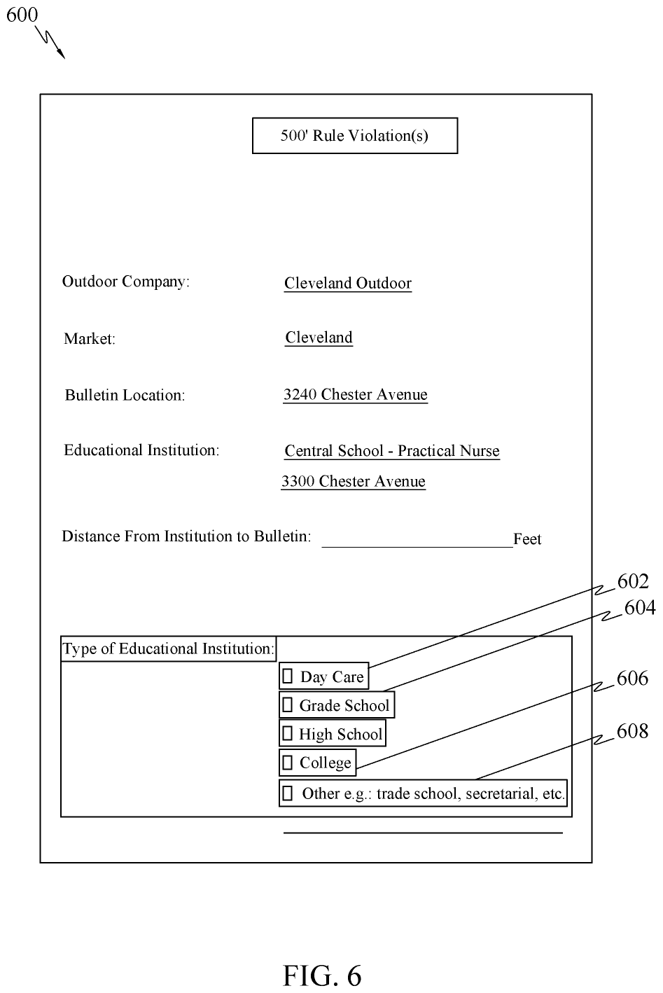

Refer to FIG. 5, a flowchart 500 illustrating checkbox detection process using the CV model 402 and the first machine learning model 406, in accordance with an embodiment.

At step 502, for instance, a digital image of the document 200 may be received. The CV model 402 may extract visual information from the digital image by applying visual processing techniques on the digital image of the document 200. The information in the digital image may be present in the form of pixels when the document gets converted into the digital image. A camera or scanner of the system 100 may be utilized to convert the document into a digital image.

In an embodiment, the combination of pixels may be represented as a symbol in a specific order and shape. For instance, the instant representation may be utilized to identify a particular shape which may match partially or completely with the checkbox symbols 202, 204, 206 present in the digital image of the document 200 (Refer FIG. 2).

At step 504, the system 100 may be configured to utilize the combination of the visual processing (performed by CV model 402) and the first machine learning model 406 to detect checkbox symbols 202, 204, 206 in the document. An overall confidence score of the detected checkbox symbol 202, 204, 206 may be improved through the combination mechanism.

In an embodiment, for instance, through the CV model 402, partial contours of the checkbox symbols 202, 204, 206 may be determined, but may fail to combine them while completing the checkbox symbols 202, 204, 206 detection. In a scenario like this, the first machine learning model 406 being a neutral network may comprise multiple layers. The higher layers of the first machine learning model 406 may combine the partial contours (detected using the CV model 402) to complete the checkbox symbol 202, 204, 206 detection. Such a feature of non-maximum suppression may be utilized to avoid spurious locations identification from the actual locations of the checkbox symbols 202, 204, 206.

At step 506, the CV model 402 may identify contours of the checkbox symbols 202, 204, 206 in order to identify parts of the checkbox symbols 202, 204, 206. For instance, the parts of the checkbox symbol 202, 204, 206 may be, but not limited to, horizontal lines, vertical lines or closed contours. The identified parts may be compared with each other to distinguish between the true checkbox symbols and the false checkboxes symbols.

The false checkboxes may be characters present in the document such as ‘o’, ‘0’, ‘ll’, ‘Q’ that may resemble the symbols that are part of the actual checkbox symbols 202, 204, 206. At step 508, the CV model 402 may be configured to remove such false checkboxes. The parts of the checkbox symbols 202, 204, 206 may be selected based on a threshold value which may be computed to cover all possible types of checkbox symbols in the digital image of the document 200, in order to extract only true checkbox symbols 202, 204, 206.

In an embodiment, the first machine learning model 406 may be trained. In the training corpus 408, locations of checkbox symbols may be manually annotated through the tagging module 414.

In an embodiment, for instance, all the checkbox symbols 202, 204, 206 may be manually annotated irrespective of the checkbox options 204, 212 being selected by users or not. This annotation may be utilized by the first machine learning model 406 to understand the possible pattern of checkbox symbols 202, 204, 206 followed by the positioning of checkbox options 210 in the training corpus 408.

In an embodiment, the positioning of the checkbox options 210 may be, but not limited to, in a row format, a column format or a matrix format. The first machine learning model 402 may be trained to detect the checkbox symbols 202, 204, 206 present in the training corpus 408.

At step 510, along with the identification of the location of the checkbox symbols 202, 204, 206, the first machine learning model 406 may be trained to detect whether the checkbox symbol 202, 204, 206 is a selected checkbox symbol 204 or unselected checkbox symbol 202, 206 by the user.

At step 512, if the first machine learning model 406 determines that there are unselected checkbox symbols 202, 206, those checkbox symbols 202, 206 may be stored in the digital repository 416 which may be utilized by the third machine learning model 412 in the extraction process of the selected checkbox symbols with the corresponding checkbox option(s) which may have been selected by the users.

At step 514, if the first machine learning model 406 determines that there are selected checkbox symbols 204, the first machine learning model 402 may classify those selected checkbox symbols 204.

In an embodiment, the first machine learning model 406 may be trained to group broken strokes in the checkbox symbols 204 to detect the checkbox symbol 204 that may have been selected by users. In order to implement that, the first machine learning model 406 may be trained to select an extra region outside the checkbox symbol 204 to cover the overflowing checkbox options that may be selected by users.

In yet another embodiment, the thickness of the strokes may be stronger outside of the checkbox symbols 204, that may be at times when user may have selected the options through a tick mark or slant mark. The starting position of the tick mark or the slant mark may be present anywhere within the checkbox symbol or outside of the checkbox symbol 204. In such scenarios, the first machine learning model 406 may be trained to select that extra region with the checkbox symbol 204, such that the extra region may be scaled to size of the checkbox symbol 204.

Hence, with the aid of the CV model 402 and the first machine learning model 406, the checkbox symbol(s) 204 selected by user may be classified and corresponding checkbox option related to the selected checkbox symbol 204 may be extracted.

### Labelling and Grouping of Checkbox Symbols

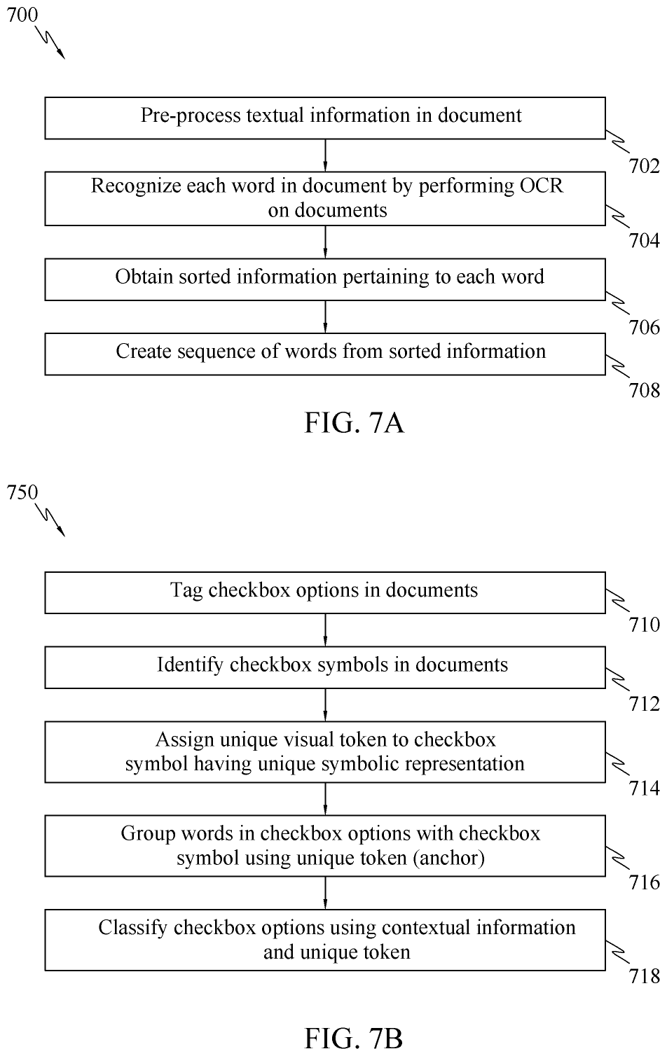

Referring to FIG. 6, a sample document 600 comprising a plurality of checkbox options 602, 604, 606, 608 is illustrated, in accordance with an embodiment.

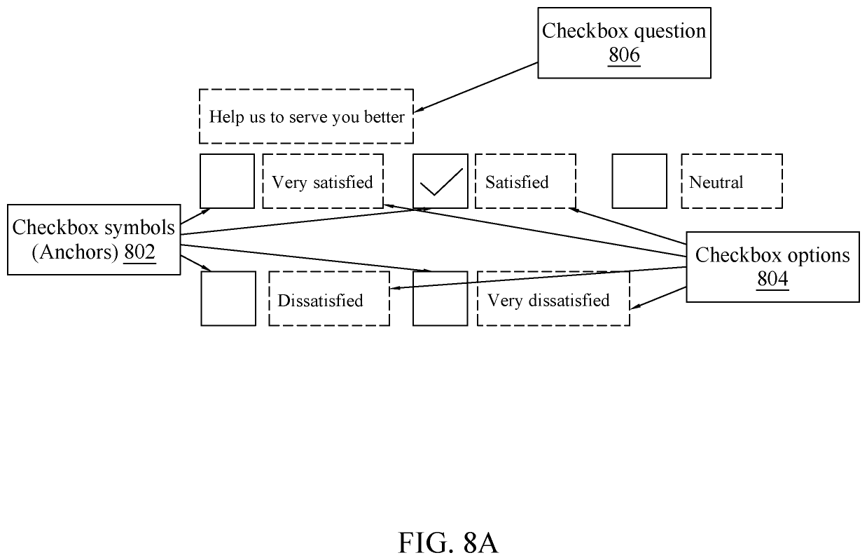

Referring to FIG. 7A, a flowchart 700 illustrating pre-processing of the textual information using the OCR module 404 is disclosed, in accordance with an embodiment.

In textual processing of documents, the main challenge is grouping the words (in checkbox options) that may be located in haphazard fashion having no restriction on positioning in the documents. In such scenarios, the arbitrary locations of the words in the document may be challenging to detect.

At step 702, for instance, the document 600 may be converted into a digital image to be sent to the OCR module 404 for pre-processing textual information in digital image of the document 600.

In an embodiment, the document 600 may comprise a group of words corresponding to the checkbox options 602, 604, 606, 608. For instance, words corresponding to the checkbox option 602 may be “Day Care” and words corresponding to the checkbox option 608 may be “Other e.g.: trade school, secretarial, etc.”

At step 704, for instance, before sending the textual information in the document 600 to the second machine learning model 410, the OCR module 404 may be utilized to pre-process the textual information in the document thereby recognizing each word in the document 600. The words present in the document 600 may be arranged in two-dimensional sequence based on the appearance of the words in the document 600. Each word in the digital image of the document 600 may be recognized by the OCR module 404.

At step 706, the OCR module 404 may obtain position information pertaining to an arrangement of top (start_x), left (start_y), height and width of each word in the digital image of the document.

At step 708, a sequence of words may be obtained from the sorted arrangement words in the digital image of the document 600.

In an embodiment, the second machine learning model 410 may be trained, wherein the sequence information of words (obtained at step 708) may be fed to train the second machine learning model 410. The second machine learning model 410 may be trained to extract the context of previous and future words from the documents in the training corpus 408. FIG. 7B illustrates a flowchart 750 illustrating training and working of the second machine learning model 410, in accordance with an embodiment.

In an embodiment, at step 710, for instance, textual words which may correspond to checkbox options 602, 604, 606, 608 may be manually tagged with a beginning token and an ending token. The tagged words corresponding to the checkbox options 602, 604, 606, 608 may be fed to train the second machine learning model 410. The documents in the training corpus 408 may be reviewed by the annotators to rightly tag the document of interest, entity of interest, and regions of interest, among others.

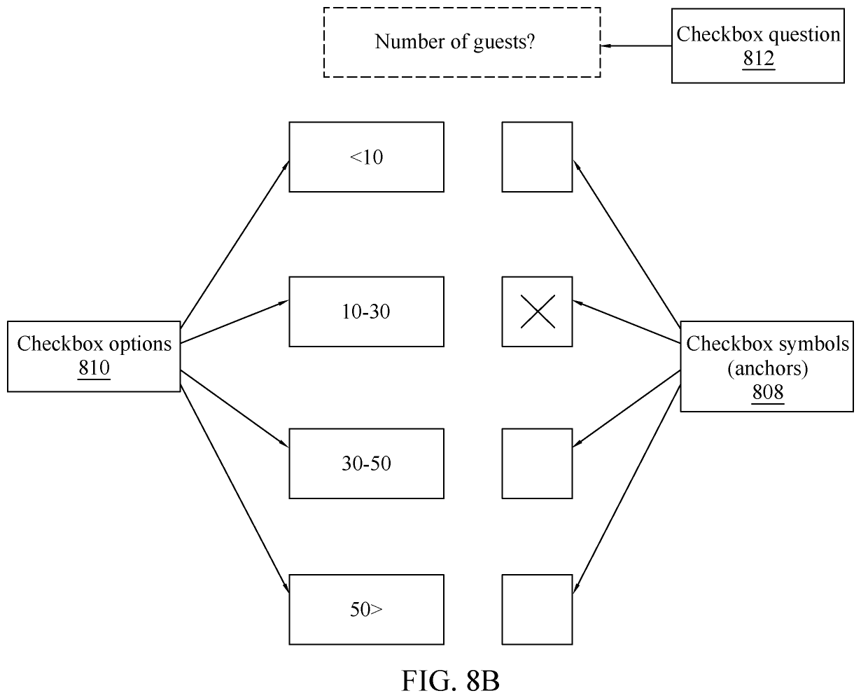

Now referring to FIGS. 8A-8B, manual tagging of checkbox symbols 802, 808 checkbox options 804, 810 and checkbox questions 806, 812 in the digital image of a sample document is illustrated, in accordance with an embodiment.

In an embodiment, while processing textual information, in the sequence information, non-textual information corresponding to checkbox symbols 802, 808 may also be present.

At step 712, the first machine learning model 406 may identify the checkbox symbols 802, 808 comprising similar symbolic representations, in terms of shape, size, contours and among others, for instance.

At step 714, once the first machine learning model 406 detects the checkbox symbols 802, 808 with unique symbolic representation, while processing the textual information in the document, the checkbox symbols 802, 808 may be separately tagged as “unique visual token” being unique in terms of symbolic representation across the document or training corpus 408. The uniqueness of the checkbox symbols 802, 808 may lie in unique symbolic representations, such that the one type of the checkbox symbols 802, 808 may be assigned one unique visual token and the same unique visual token may be replicated for similar symbolically represented checkbox symbols 802, 808 across the documents in training corpus 408.

In an embodiment, different unique visual tokens may be assigned to checkbox symbols 802, 808 that may have different symbolic representations. As a matter of fact, the checkbox symbol 802, 808 that may be common across all types of documents in terms of shape, size and related attributes may be treated as one type of checkbox symbol 802, 808 and may be assigned a unique visual token. Likewise, different checkbox symbols may be assigned unique visual tokens accordingly.

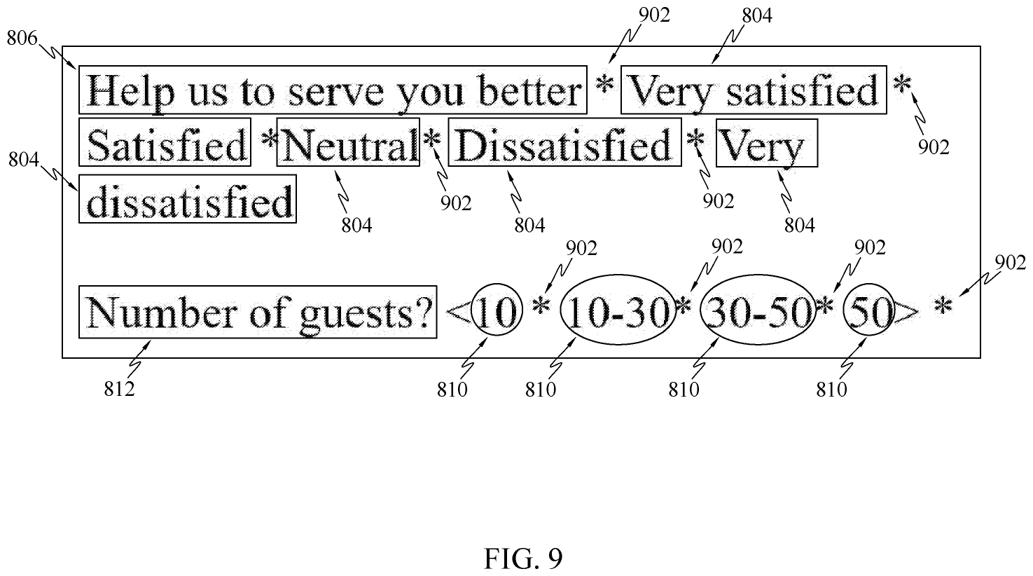

Referring to FIG. 9, a unique visual token 902 may be introduced in the sequence of text comprising checkbox options 804, 810 and checkbox questions 806, 812 in accordance with an embodiment. At step 716, the unique visual token 902 may be utilized as an anchor for grouping the words corresponding to the checkbox options 804, 810 pertaining to corresponding checkbox symbol 802, 808 respectively. Such an introduction of the unique visual token 902 may improve grouping of words corresponding to the checkbox options 804, 810.

In an embodiment, the textual information may be grouped with the non-textual information present in the training corpus 408.

In an embodiment, the checkbox symbols 802, 808 may be located in any of the four directions as the top, the left, the bottom, or the right side of the checkbox options 804, 810. The tagged information pertaining to checkbox symbols 802, 808 may be utilized by the CV model 402 and the first machine learning model 406 to locate the checkbox symbols 802, 808 across the document 800, for instance.

In an embodiment, the second machine learning model 410 may be trained to infer the context for the corresponding checkbox options 804, 810 in the vicinity of the checkbox symbols 802, 808, for instance. The nearby words may be assigned with beginning and end tokens for the checkbox options 804, 810. For instance, the instant operation may be carried out by a transformer-based language model for example, “BERT” which may be utilized by the second machine learning model 404 to classify the word tokens.

At step 718, the contextual information and the unique visual token 902 may both aid in classification of the checkbox options 804, 810.

In an embodiment, the system 100 may be configured to utilize the combination of the visual processing by the CV model 402 and the first machine learning model 406, and the OCR module 404 and the second machine learning model 410 for textual processing in the digital documents.

### Extraction of Checkbox Symbols

Once the words in checkbox options 804, 810 are grouped using the unique visual token 902 as discussed in foregoing, extraction of the checkbox questions 806, 812 with corresponding selected options 804, 810 needs to be processed.

In an embodiment, for extraction of the checkbox questions 806, 812 with corresponding selected options 804, 810, the checkbox options 804, 810 may be listed based on the checkbox questions 806, 812. The possible checkbox options 804, 810 may be sourced based on the checkbox questions 806, 812 from the digital repository 416.

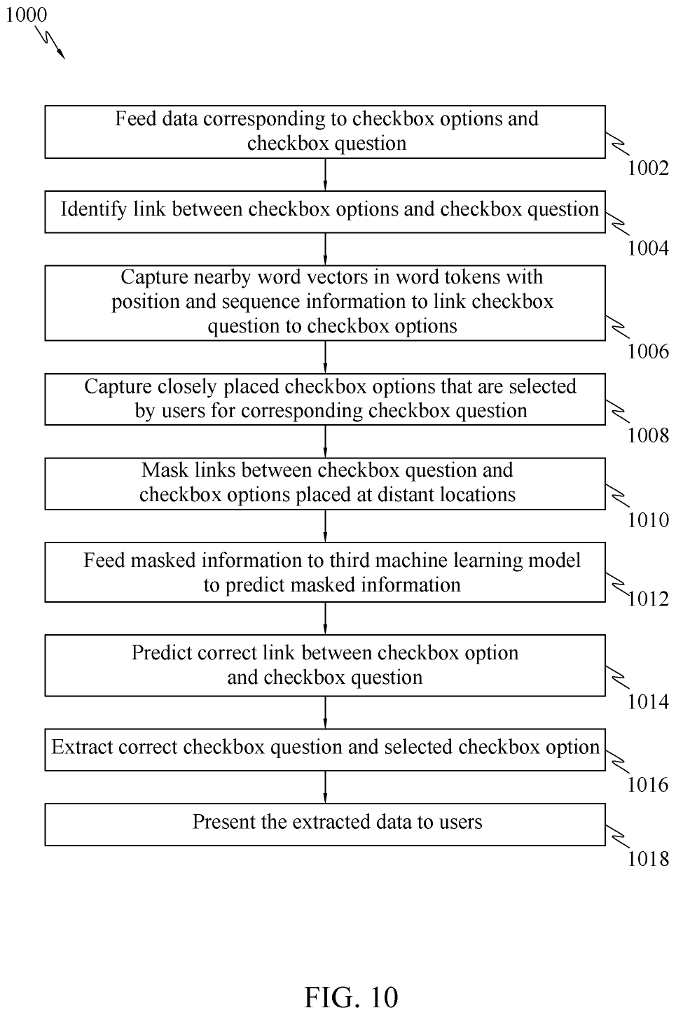

FIG. 10 is a flowchart 1000 illustrating training and working of the third machine learning model 412 to extract checkbox questions 806, 812 with corresponding selected options 804, 810, in accordance with an embodiment.

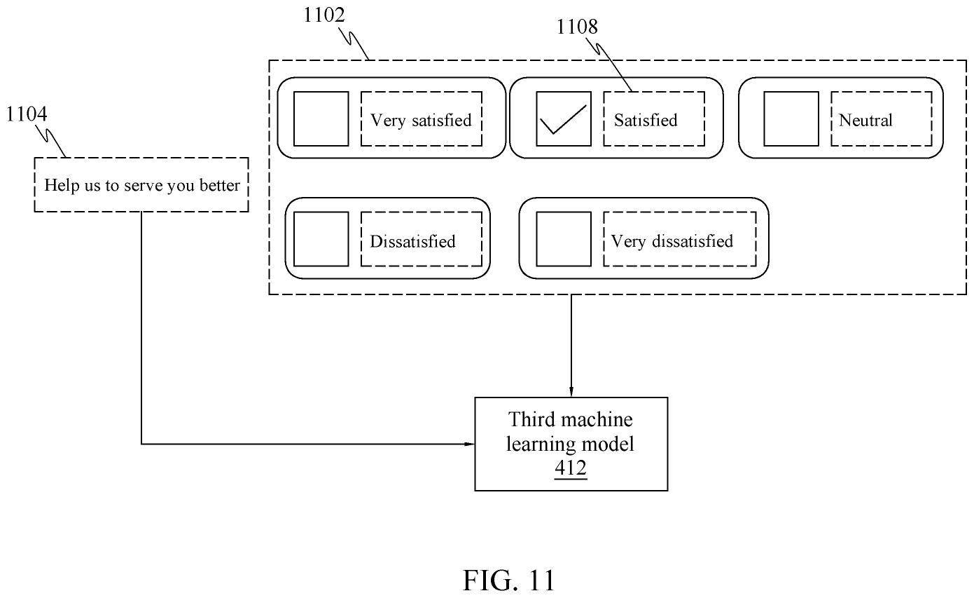

Now referring to FIG. 11, information pertaining to the checkbox options 1102 and the checkbox question 1104 may be fed to train the third machine learning model 412. The third machine learning model 412 may have to extract selected checkbox option 1108 with corresponding checkbox question 1104 as a final output and present that to users. At step 1002, information pertaining to the checkbox options 1102 and the checkbox question 1104 may be fed to train the third machine learning model 412.

At step 1004, in order to train the third machine learning model 412, it may be required to map or link the checkbox options 1102 to an original checkbox question 1104.

In an embodiment, the possibilities of mapping or linking may be one-to one, one to many and many to one. As a matter of fact, multiple selected checkbox options 1102 may be available for a checkbox question 1104. In order to extract selected checkbox symbol, one or many checkbox options 1102 may require to be mapped or linked to a particular checkbox question 1104. The linking module 418 may be configured to link the checkbox options 1104 with the checkbox question 1102. The third machine learning model 412 may be trained to identify a link between the checkbox options 1102 and the corresponding checkbox question 1104.

At step 1006, the third machine learning model 412 may be trained to capture nearby word tokens with position and sequence information in order to link the checkbox questions 1104 and the checkbox options 1102. Word vectorization and tokenization is a word embedding technology of transforming text into numeric tensors. It may include application of some tokenization scheme and then associating numeric vectors into the generated word tokens. The generated word vectors may be packed into sequence tensors with position and sequence information and may be fed into a deep neural network, for instance a third machine learning model 412.

In an embodiment, the checkbox options 1102 may be placed below the checkbox question 1104 or above the checkbox question 1104 or in a row format, and among others. The third machine learning model 412 may utilize the nearby word tokens to select one of the checkbox options 1102 (for instance, the first checkbox option) from the group of word tokens in the checkbox options 1102.

In an embodiment, the third machine learning model 412 may be trained to capture other related checkbox options 1108 that may have been selected by users. At step 1008, the third machine learning model 412 may be trained to capture closely placed checkbox options 1102 with respect to the checkbox question 1104.

In an embodiment, in order to identify the linking of the checkbox options 1102 which may be placed at distant locations from the checkbox question 1104, the third machine learning to model 412 may be trained with a masking approach. At step 1010, the masking module 420 may be configured to mask the checkbox question 1104 and checkbox options 1102 randomly.

At step 1012, the masking module 420 may be configured to feed the masked information to the third machine learning model 412 to train the third machine learning model 412 to predict the accurate link. The masked information may be present in the form of links between the checkbox question 1104 and the checkbox options 1102.

At step 1014, the links between the checkbox question 1104 and the checkbox options 1102 may be masked and the third machine learning model 412 may be trained to predict the accurate link by analysing nearby tokens. The context between the checkbox question 1104 and the checkbox options 1102 may be analysed by the third machine learning model 412 to output the accurate link.

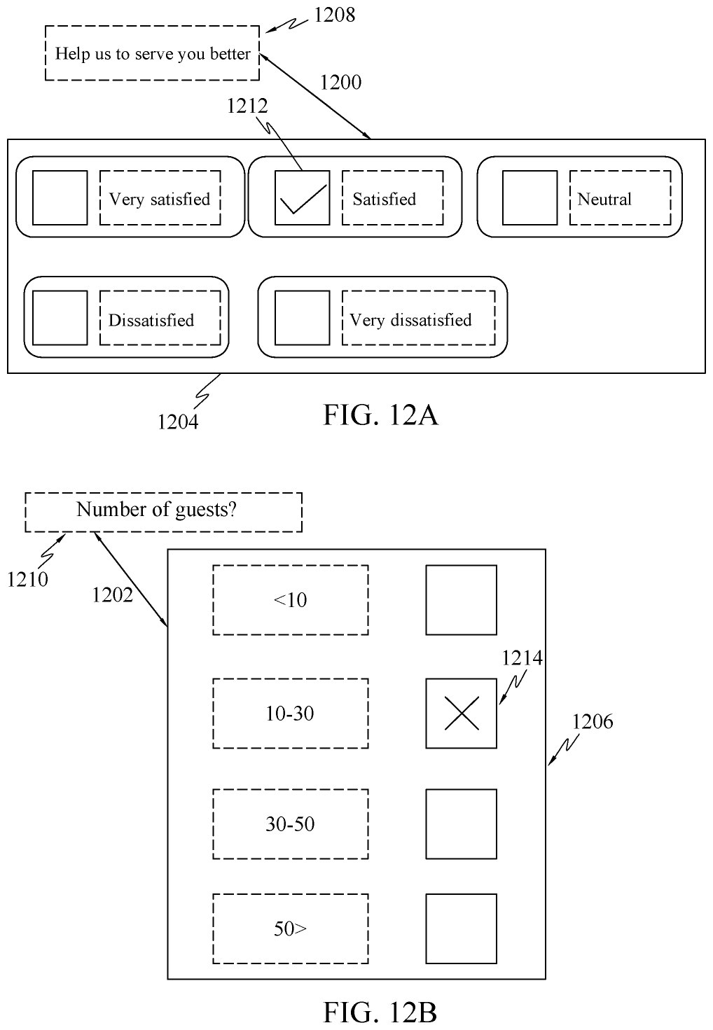

Referring to FIGS. 12A-12B, in the training period, a plurality of links 1200, 1202 may be generated between the checkbox options 1204, 1206 and the checkbox questions 1208, 1210 respectively to train the third machine learning model 412, in accordance with an embodiment. The predicted link may help in the successful extraction of checkbox questions 1208, 1210 with the corresponding selected checkbox option 1212, 1214 out of all the checkbox options 1204, 1206.

At step 1016, the third machine learning model 412 may extract the predicted checkbox question and corresponding checkbox option that may have been selected by user.

At step 1018, the final output corresponding to the extracted checkbox question and corresponding selected checkbox option may be presented to users.

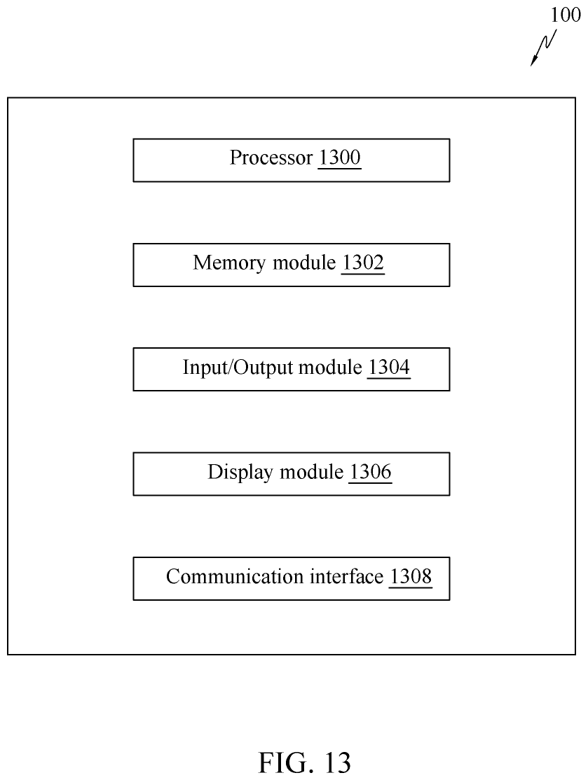

FIG. 13 illustrates a hardware configuration of the system 100, in accordance with an embodiment.

In an embodiment, the system 100 may include one or more processors 1300. The processor 1300 may be implemented as appropriate in hardware, computer-executable instructions, firmware, or combinations thereof. Computer-executable instruction or firmware implementations of the processor 1300 may include computer-executable or machine-executable instructions written in any suitable programming language to perform the various functions described. Further, the processor 1300 may execute instructions, provided by the various modules of the system 100.

In an embodiment, the processors 1300 may include graphic processing units (GPUs) to be utilized to process multiple bits of data simultaneously. The GPUs are capable of processing many complex tasks. These are designed to process tasks relating to, but not limited to, graphics, videos and content.

In an embodiment, the system 100 may include a memory module 1302. The memory module 1302 may store additional data and program instructions that are loadable and executable on the processor 1300, as well as data generated during the execution of these programs. Further, the memory module 1302 may be volatile memory, such as random-access memory and/or a disk drive, or non-volatile memory. The memory module 1302 may be removable memory such as a Compact Flash card, Memory Stick, Smart Media, Multimedia Card, Secure Digital memory, or any other memory storage that exists currently or will exist in the future.

In an embodiment, the system 100 may comprise input/output modules 1304.

In an embodiment, the input modules 1304 may provide an interface for input devices such as keypad, touch screen, mouse and stylus among other input devices to users. The input modules 1304 may include camera or scanner of the system 100. The input modules 1304 may provide users an interface to manually annotate or tag digital version of input documents.

In an embodiment, the system 100 may comprise output modules 1304 that may provide an interface for output devices such as display screen, speakers, printer and haptic feedback devices, among other output devices.

In an embodiment, the system 100 may include a display module 1306 that may be configured to display content. The display module 1306 may also be used to receive an input from a user. The display module 1306 may be of any display type known in the art, for example, Liquid Crystal Displays (LCD), Light emitting diode displays (LED), Orthogonal Liquid Crystal Displays (OLCD) or any other type of display currently existing or may exist in the future.

In an embodiment, the system 100 may comprise a communication module comprising a communication interface 1308, configured to provide a communication interface between the system 100, server 106 and external networks. The communication interface 1308 may include a modem, a network interface card (such as Ethernet card), a communication port, or a Personal Computer Memory Card International Association (PCMCIA) slot, among others. The communication interface 1308 may include devices supporting both wired and wireless protocols.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for detecting and extracting at least one checkbox symbol and at least one checkbox option pertaining to at least one checkbox question from a digital document, the system comprises one or more processors configured to:
identify location of the at least one checkbox symbol and its corresponding location with respect to the at least one checkbox option;
determine context of textual information corresponding to the at least one checkbox option using textual processing;
identify pictorial representation of non-textual information corresponding to the at least one checkbox symbol using visual processing;
group the textual information corresponding to the at least one checkbox option with the corresponding at least one checkbox symbol by a unique visual token using the textual processing and the visual processing on the document, wherein the unique visual token is utilized as an anchor to group the textual information with the non-textual information in the digital document; and
identify at least a link between the at least one checkbox option with its corresponding checkbox question.

2. The system according to claim 1, wherein the one or more processors are configured to:
detect location of at least one checkbox symbol selected by a user using a computer vision model, wherein the computer vision model is configured to eliminate detection of false checkboxes in the digital document; and
utilize a first machine learning model to detect and validate the at least one checkbox symbol in the digital document.

3. The system according to claim 2, wherein the one or more processors are configured to train the first machine learning model by:
receiving annotation indicating locations of checkbox symbols in a training corpus, wherein in the training corpus, the checkbox symbols comprise of both user-selected and user-unselected checkbox symbols.

4. The system according to claim 3, wherein the first machine learning model is trained to:
validate status of the checkbox symbols and allow selected checkbox symbols to be detected; and
identify a corresponding location of the at least one checkbox option with respect to the at least one detected checkbox symbol.

5. The system according to claim 1, wherein the one or more processors are configured to:
determine the context of the textual information corresponding to the at least one checkbox option in the digital document using the textual processing, wherein the context of the textual information is determined by pre-processing the textual information in the digital document using an optical character recognition module by:
converting the document into an image;
arranging words in the textual information into a two-dimensional sequence;
obtaining a sorted information for each of the words present in the at least one checkbox option; and
feeding the sorted information to train a second machine learning model.

6. The system according to claim 5, wherein the second machine learning model is trained by:
creating a sequence of words from the sorted information of words present in the textual information;
tagging words corresponding to the at least one checkbox option corresponding to the at least one checkbox symbol with a start point and an end point, wherein the at least one checkbox symbol is detected using the first machine learning model;
tagging the at least one checkbox question corresponding to the at least one option in the textual information; and
tagging the at least one checkbox symbol.

7. The system according to claim 6, wherein the first machine learning model is trained to detect the at least one checkbox symbol by identifying pictorial representation of the at least one checkbox symbol.

8. The system according to claim 6, wherein the second machine learning model is further trained by:
grouping the tagged information pertaining to the at least one checkbox option, the at least one checkbox question and the at least one checkbox symbol by the unique visual token, wherein:
the unique visual token is assigned to the at least one checkbox symbol while processing the textual information in digital document, wherein words corresponding to the at least one checkbox option are grouped with the at least one checkbox symbol using the unique visual token; and
classify the at least one checkbox option using the textual processing and the unique visual token.

9. The system of in claim 8, wherein the unique visual token corresponds to the non-textual information in the digital document which is utilized to classify the textual information in the digital document.

10. The system according to claim 8, wherein a plurality of unique visual tokens are assigned based on corresponding plurality of pictorial representations of corresponding checkbox symbols across the digital documents.

11. The system according to claim 6, wherein the tagged information corresponding to the at least one checkbox option and the at least one checkbox question is extracted to be fed to a third machine learning model, wherein the third machine learning model is trained to:
link the at least one checkbox option to the at least one checkbox question using a linking module, wherein the third machine learning model is trained to identify a relationship between the at least one checkbox option and the at least one checkbox question based on the tagged information pertaining to the at least one checkbox option and the at least one checkbox question.

12. The system according to claim 11, wherein the third machine learning model is trained by:
masking checkbox questions and checkbox options randomly in a training corpus using a masking module;
generating a plurality of links in the training corpus, wherein the plurality of links between the checkbox options and the checkbox questions are randomly masked;
enabling the third machine learning model to predict a masked information in the training corpus, wherein the masked information pertains to a linking of the at least one checkbox question to the at least one checkbox option, wherein, the third machine learning model with the help of the second machine learning model is trained to:
analyze nearby words and context using position and sequence information of word vectors in word tokens between the checkbox options and the checkbox questions;
predict at least a correct link between the at least one checkbox question and the at least one checkbox option; and
extract the at least one checkbox question with the at least one checkbox option.
